(19) United States
(12) Patent Application Publication
(10) Pub. No.: US 2010/0112531 A1
(43) Pub. Date: May 6, 2010

(54) Safety Poker Game

(76) Inventor: Dale A. Bruhl, Sylvania, OH (US)

Correspondence Address: MACMILLAN SOBANSKI & TODD, LLC, ONE MARITIME PLAZA FIFTH FLOOR, 720 WATER STREET, TOLEDO, OH, 43604-1619, US

(21) Appl. No.: 12/262,544

(22) Filed: Oct. 31, 2008

(51) Int. Cl. G09B 19/22

(52) U.S. Cl. 434/129

(57) ABSTRACT

A game includes a game board having a playing surface. The playing surface has a plurality of player boxes and a common card box. Each player box has a name box and a card box. Each name box is configured for a game participant name. A container is configured to contain a plurality of playing cards. The container allows for a blind draw of the playing cards. The container includes a common card. A plurality of playing cards is initially positioned in the container. The drawn playing cards are attached to the card box of each game participant.

### TECHNICAL FIELD

The invention relates generally to games. More specifically, the invention is directed to a game of chance relating to employee focus on industry safety procedures.

### BACKGROUND OF THE INVENTION

Businesses are continually faced with a myriad of rising costs. Accordingly, businesses must continually explore methods of reducing costs. The business costs can be fixed or variable. One example of a variable business cost is workers compensation. Typically, a business incurs worker compensation costs when employees are injured on-the-job and subsequently file workers compensation claims. Accordingly, businesses are interested in preventing and lessening the severity of injuries. One example of activities undertaken by businesses to prevent injuries is education of the employees as to proper and safe procedures for accomplishing potentially hazardous work tasks. As the education of the employees is conducted, businesses are then keen to maintain the focus of the employees on the proper and safe procedures. It would be advantageous to provide safety education materials for business employees.

### SUMMARY OF THE INVENTION

A game includes a game board having a playing surface. The playing surface has a plurality of player boxes and a common card box. Each player box has a name box and a card box. Each name box is configured for a game participant name.

A container is configured to contain a plurality of playing cards. The container allows for a blind draw of the playing cards. The container includes a common card.

A plurality of playing cards is initially positioned in the container. The drawn playing cards are attached to the card box of each game participant.

### BRIEF DESCRIPTION OF THE DRAWINGS

FIG. 1 is front view of a playing board according to the invention;

FIGS. 2a-2c are plan views of the backs of playing cards, each having a safety-related slogan, used with the playing board of FIG. 1;

FIGS. 2d-2f are plan views of the fronts of playing cards, each having a safety-related slogan, used with the playing board of FIG. 1

FIG. 3 is a front view of the playing board of FIG. 1 during game play;

FIG. 4 is a front view of the playing board of FIG. 1 at the end of game play;

FIG. 5 is an alternate embodiment of the playing board of FIG. 1, illustrating a focus on a different business issue.

### DETAILED DESCRIPTION OF THE INVENTION

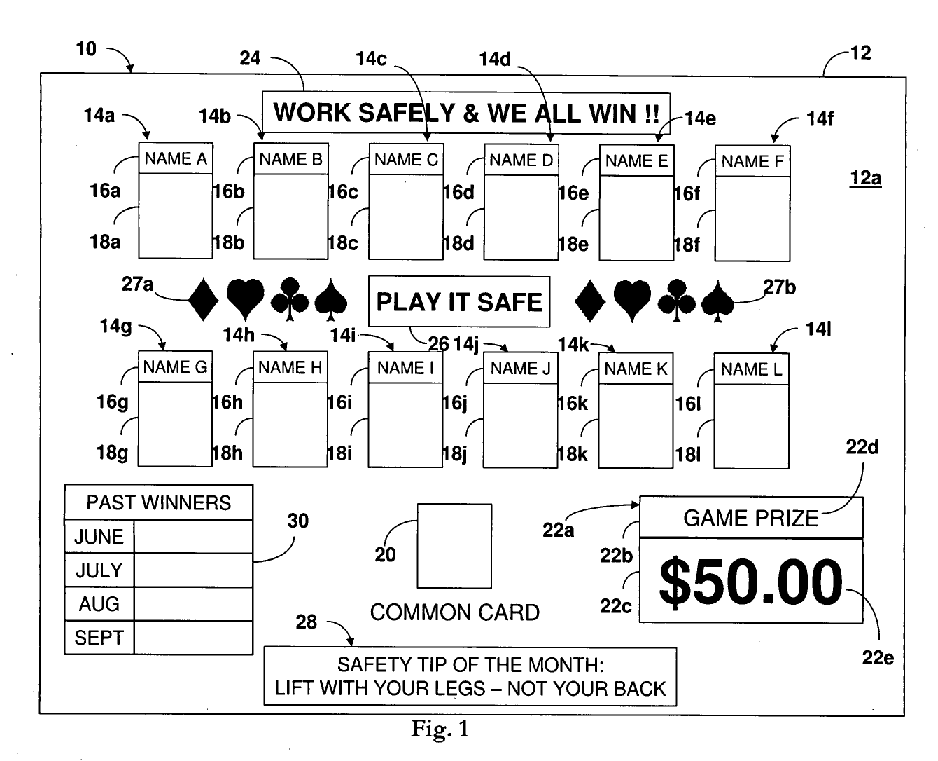

Referring to FIG. 1, a safety poker game is indicated generally by the reference number 10. The safety poker game 10 includes a game board 12 having a playing surface 12a. As will be explained in more detail below, the game board 12 is configured such that playing cards are attached to the playing surface 12a. The game board 12 can have any suitable size and shape, and can be made of any suitable material, such as for example cardboard, vinyl or plastic. The playing surface 12a can be any surface suitable for writing or marking and attaching playing cards. In the illustrated embodiment, the playing surface 12a is a dry erase surface. However, the playing surface 12a can be other suitable surfaces.

The playing surface 12a of the game board 12 includes a plurality of player boxes 14a-14l, a common card box 20 and an optional award box 22a. Each of the player boxes, 14a-14l, includes a name box and a card box, 16a-16l and 18a and 18l, respectively. While the embodiment shown in FIG. 1 illustrates a quantity of twelve player boxes, 14a-14l, it should be understood that the playing surface 12a can include any number of player boxes.

Still referring to FIG. 1, the player boxes 14a-14l, the name boxes 16a-16l, the card boxes 18a-18l and the common card box 20 have a rectangular shape. However, the player boxes 14a-14l, the name boxes 16a-16l, the card boxes 18a-18l and the common card box 20 can have other suitable shapes.

Optionally, the playing surface 12a can include an award box 22a. The award box 22a includes an award title box 22b and an award amount box 22c. The award title box 22b includes award title indicia 22d. As still shown in FIG. 1, the award title indicia 22d provide a title for the award box 22. However, the award title box 22b can contain indicia 22d that addresses other subject matter. The award amount box 22c includes award amount indicia 22e that provides the dollar amount to be awarded during the current game. The award amount indicia 22e is shown as $50.00. However, the dollar amount awarded during the game can be more or less than $50.00.

The playing surface 12a also includes various indicia 24, 26, 27a, 27b and 28. The indicia 24, 26, 27a, 27b and 28 can be any desired message, symbol, slogan or logo. While the embodiment shown in FIG. 1 illustrates the indicia 24, 26, 27a, 27b and 28, it should be understood that the indicia 24, 26, 27a, 27b and 28 is optional and not necessary for the operation of the safety poker game 10.

As shown in FIG. 1, the playing surface 12a also optionally includes a prior award box 30. The prior award box 30 is configured to display past winners of the safety poker game 10. The prior award box 30 includes past winners for a quantity of four months. However, the prior award box 30 can display more or less than four months of winners. While the embodiment shown in FIG. 1 illustrates the prior award box 30, it should be understood that the prior award box 30 is optional and not necessary for the operation of the safety poker game 10.

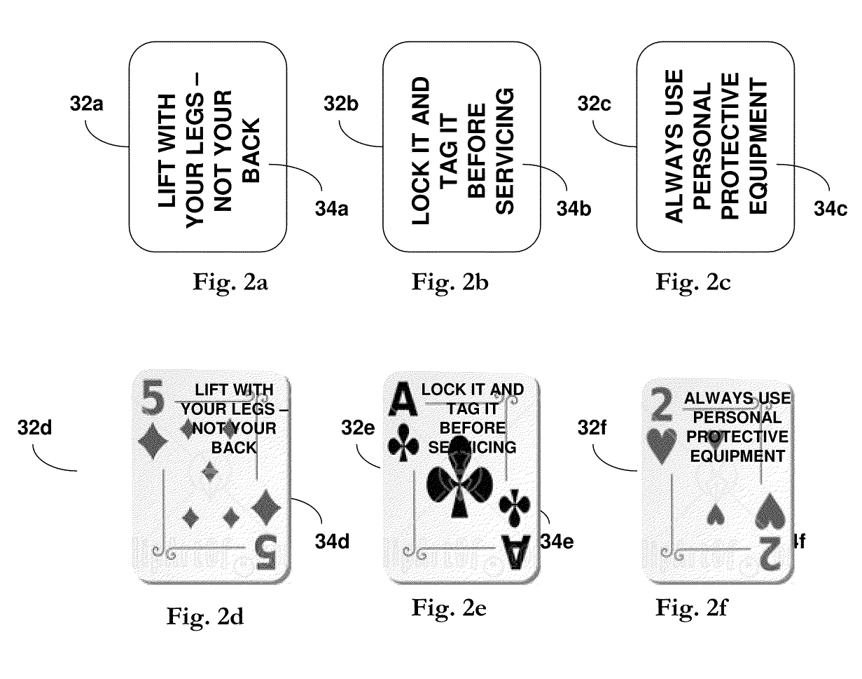

Referring now to FIGS. 2a-2f, the safety poker game 10 is played with standard decks of fifty-two playing cards. The number of decks of playing cards and the number of game boards 12 used depends on the number of game participants. For example, a quantity of one to twelve game participants requires a single deck of playing cards and a single game board 12. For a quantity of thirteen to twenty four game participants, two decks of playing cards and two game boards 12 are used.

Optionally, the fronts and the backs of the playing cards can be marked with indicia. As shown in FIGS. 2a-2c, the backs of the playing cards, 32a-32c, include indicia, 34a-34c, which comprise safety-related short sayings. As shown in FIGS. 2d-2f, the fronts of the playing cards, 32d-32f, include indicia, 34d-34f, which comprise safety-related short sayings. However, the playing cards, 32a-32f, can include other desired indicia.

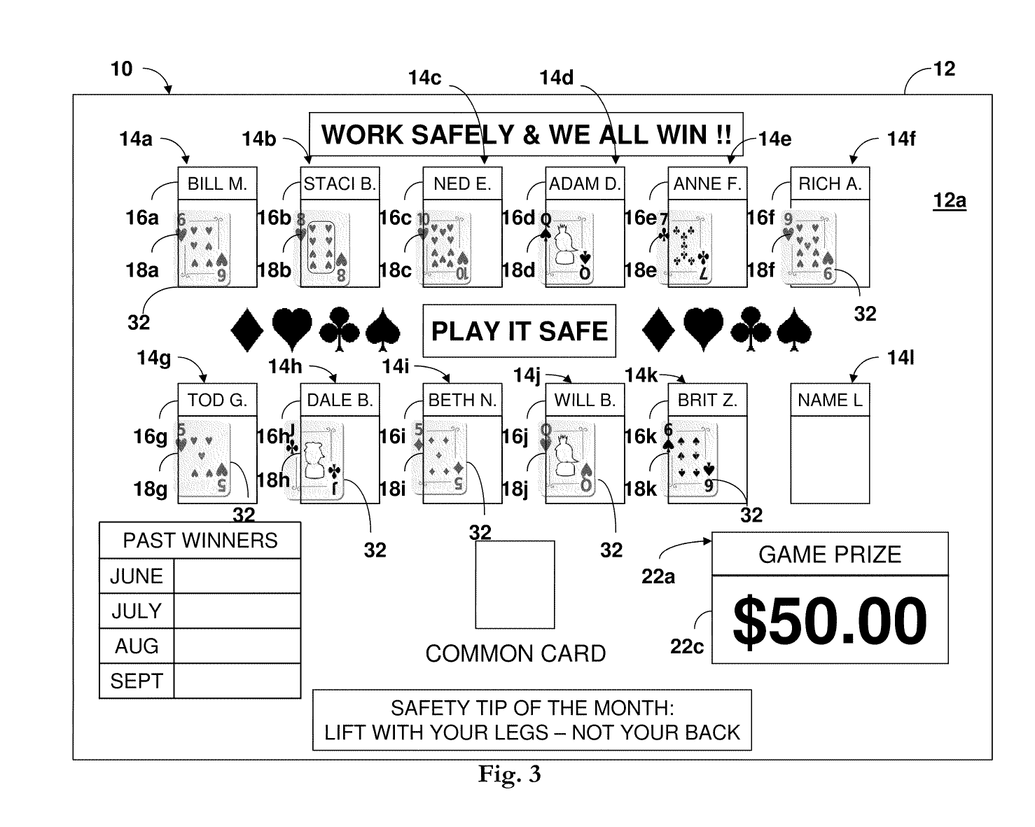

Referring now to FIG. 3, the game is started as each game participant is assigned a player box 14a-14k. In an embodiment, eleven participants are included in this game. Accordingly, the names of the eleven participants are entered into the name boxes 16a-16k. Player box 14l is left blank and is not used. The amount of the award is determined and entered into award amount box 22c. As indicated above, the amount of the award can be any desired amount.

A standard deck of playing cards (not shown) is shuffled and placed into a container (not shown). The container is configured to allow a blind, random selection of the game cards by the game participants. In an embodiment, the container can be a bag made of an opaque material. In other embodiments, the container can be a raffle drum or other devices suitable to allow a blind, random selection of the game cards by the game participants.

Sequentially, each game participant draws a playing card 32 from the container. The drawn playing card 32 for each game participant is attached to the respective card box, 18a-18k, for each game participant. As a first example, FIG. 3 illustrates a first game participant, BILL M., having drawn a six of hearts as his first playing card 32. The six of hearts playing card 32 is attached to the card box 18a associated with the player box 14a for the game participant BILL M. Each game participant continues in this same manner until all of the game participants have selected their first playing cards 32 and all of the playing cards 32 have been attached to the respective card boxes 18a-18k. The playing cards are attached to the playing surface 12a in any suitable manner, such as for example, thumb tacks and adhesive tape.

In an embodiment, the safety poker game 10 is configured for play over the course of four consecutive time periods such that a game participant draws one playing card in each time period. The time periods can coincide, for example, with the weekly pay periods of the game participants. Accordingly, a game participant draws one playing card per week for four consecutive weeks thereby allowing one game to be started and completed over the span of consecutive four weeks. However, the time periods can be other periods, such as for example, over a span of a number of days, months, or years. In other embodiments, the time periods can based on any desirable increment, such as for example, the days or weeks spanning a selected business contract or a holiday season.

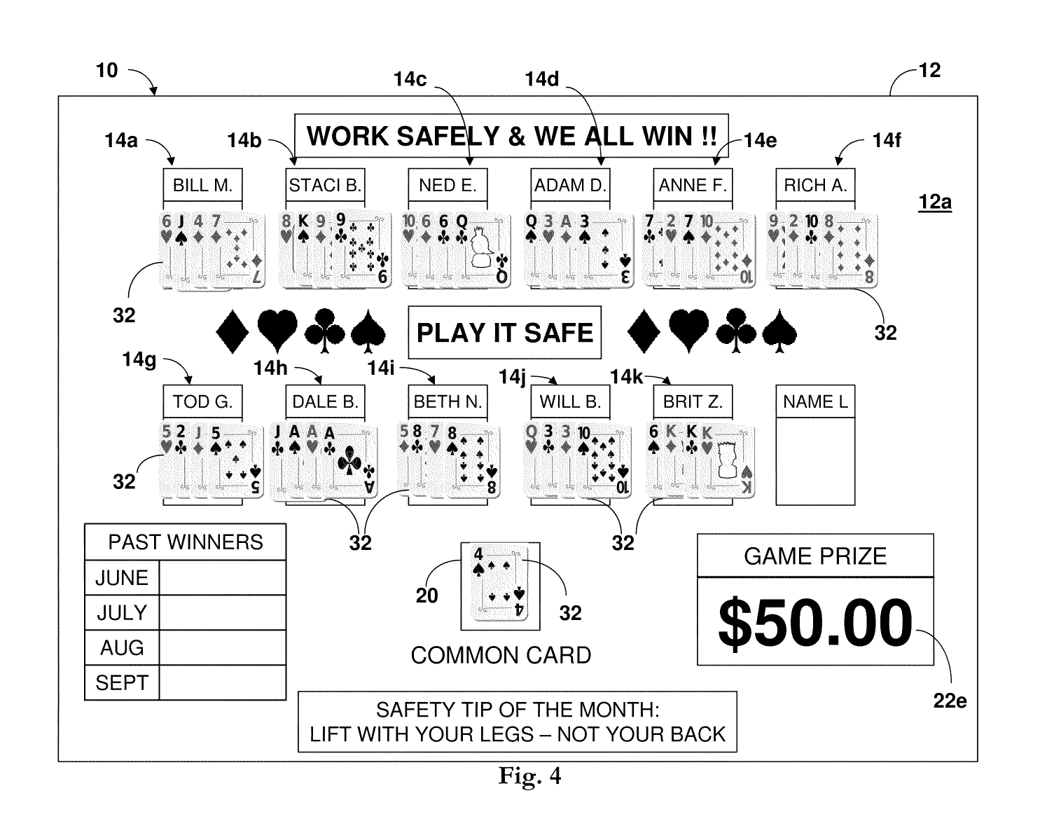

Referring now to FIG. 4, the safety poker game 10 has completed four time periods. Accordingly, each game participant has drawn four playing cards 32 and each playing card 32 has been attached to the appropriate player's box, 14a-14k. At the fourth time period, after each game participant has drawn their last playing card 32, a common playing card 32 is drawn from the container and attached to the common card box 20. Each game participant can use the playing cards 32 within their player's box and the common playing card 32 within the common card box 20 to form their best five-card poker hand. The game participant with the best poker hand wins the award amount 22e. As shown in FIG. 4, game participant Dale B. has a winning five-card poker hand of three aces.

The common card is not drawn until all of the game participants have drawn their fourth (last) playing card 32. Accordingly, each game participant is unable to predict a winner until the last time period and each game participant has a chance to win, thereby maintaining the interest until the end of the safety poker game 10.

In the event of an injury or accident involving any of the game participants during the four time periods of the safety poker game 10, all of the playing cards are removed from the player's boxes 14a-14k and the game is terminated without a winner.

A business using the safety poker game 10 will experience many benefits. First, the business can select and involve each employee involved in a potentially hazardous task in the game. Accordingly, each employee with the potential to experience an accident or injury can be involved. Second, each game participant receives safety-related education, both through the safety-related slogans on the backs of the playing cards and through the safety-related indicia located on the game board 12. Third, the safety poker game acts as a constant reminder and a constant point of focus, over an extended period of time, as to the importance of safety in the workplace. Fourth, the employees are forced to act as a unit to prevent accidents and injuries. Fifth, any accident or injury incurred by any of the game participants will be known by all of the game participants, thereby instilling an element of peer pressure into the workplace. Sixth, any accident or injury incurred by any of the game participants will have an impact on all of the game participants, thereby reinforcing the safety-related message to all of the game participants. Lastly, the business will benefit from net reduced costs as the cost of the safety poker game 10 will be offset by lower worker compensation claim costs.

While the embodiments of the poker game 10 described above concern the business area of safety and worker's compensation claims, it should be appreciated that other embodiments of the poker game can address additional suitable areas of a business needing improvement. For example, the poker game 10 can address business concerns such as overdue collections, lack of sales, excess inventory, late shipments, or excess cell phone usage.

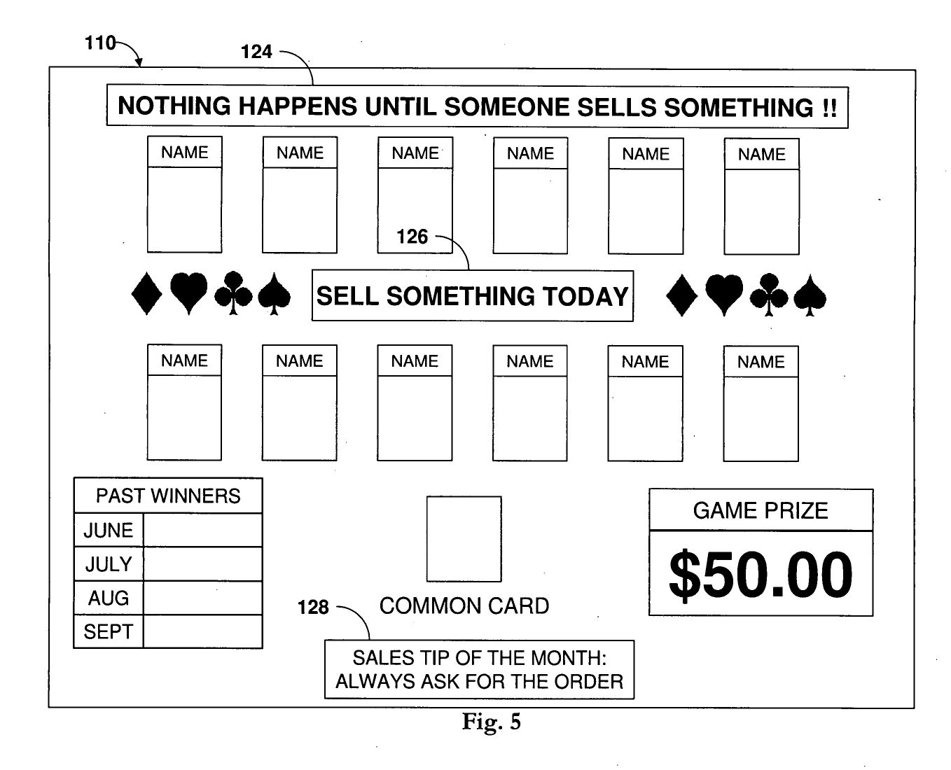

Referring now to FIG. 5, an alternate embodiment of the poker game 110 is illustrated. As shown in FIG. 5, the indicia 124, 126 and 128 has been revised to focus on the business area of sales. The method of playing the poker game 110 is the same in this embodiment as described above.

While the invention as been described with reference to particular embodiments, it should be understood that various changes may be made and equivalents may be substituted for elements thereof without departing from the essential scope of the invention. In addition, many modifications may be made to adapt a particular situation or material to the teachings of the invention without departing from the essential scope thereof. Therefore, it is intended that the invention not be limited to the particular embodiments, but that the invention shall include all embodiments falling within the scope of the claims.

We claim:

1. A game comprising:
a game board having a playing surface, the playing surface having a plurality of player boxes and a common card box, each player box having a name box and a card box, each name box being configured for a game participant name;
a container configured to contain a plurality of playing cards, wherein the container allows for a blind draw of the playing cards, wherein the container includes a common card; and
a plurality of the playing cards initially positioned in the container, wherein drawn playing cards are attached to the card box of each game participant.

2. The game of claim 1, wherein the playing surface includes indicia related to a business concern.

3. The game of claim 2, wherein the indicia includes a tip of the month.

4. The game of claim 1, wherein the playing surface includes indicia concerning a game award.

5. The game of claim 1, wherein the playing surface includes indicia concerning past winners of the game.

6. The game of claim 1, wherein the container is a bag.

7. The game of claim 6, wherein the bag is made of an opaque material.

8. The game of claim 1, wherein the playing cards have a front surface and a back surface, wherein a slogan is positioned on the back surface of each playing card.

9. A method of playing a game, comprising the steps of:
providing a game board having a playing surface, the playing surface having a plurality of player boxes and a common card box, each player box having a name box and a card box, each name box being configured for a game participant name;
entering a game participant name into a name box;
providing a container configured to contain a plurality of playing cards, the container allowing for a blind draw of the playing cards;
providing a plurality of playing cards initially positioned in the container;
drawing of the playing cards by the game participants;
attaching the drawn playing cards to the card box of each game participant;
repeating the drawing of the drawing of the playing cards and attaching of the drawn playing cards to the card boxes for four time periods;
drawing a common card; and
determining the game participant name.

10. The method of claim 9, wherein the playing surface includes indicia related to a business concern.

11. The method of claim 10, wherein the indicia includes a tip of the month.

12. The method of claim 9, wherein the playing surface includes indicia concerning a game award.

13. The method of claim 9, wherein the playing surface includes indicia concerning past winners of the game.

14. The method of claim 9, wherein the container is a bag.

15. The method of claim 14, wherein the bag is made of an opaque material.

16. The method of claim 9, wherein the playing cards have a front surface and a back surface, wherein a slogan is positioned on the back surface of each playing card.
